(19) United States
(12) Patent Application Publication
(10) Pub. No.: US 2005/0165789 A1
(43) Pub. Date: Jul. 28, 2005

(54) Client-centric information extraction system for an information network

(76) Inventors: Steven Nathaniel Minton, El Segundo, CA (US); Bryan Fredric Pelz, Bakersfield, CA (US)

Correspondence Address: LIU & LIU, 444 S. FLOWER STREET SUITE 1750, LOS ANGELES, CA, 90071, US

(21) Appl. No.: 11/021,552

(22) Filed: Dec. 22, 2004

Related U.S. Application Data
(60) Provisional application No. 60/531,859, filed on Dec. 22, 2003.

(51) Int. Cl. G06F 7/00

(52) U.S. Cl. 707/10

(57) ABSTRACT

A client-centric online navigation architecture that extracts relevant data from documents as a user is interacting with an information network, proposes related information services based on the types of data and data values extracted from the current viewed document, and presents a menu of related information. A browser plug-in extracts data from a web page as a user browses the Internet, and provides additional services to the web user as he browses. Data extraction wrappers created by a developer are distributed to the client machines. The wrapper supported information extraction process occurs apart from the content server, e.g., on the client machine or a proxy server. Extracted data can trigger the launching of services, called “hyperservices”, either on the local machine or remote machines.

This application claims the priority of U.S. Provisional Application No. 60/531,859, filed Dec. 22, 2003, which is fully incorporated by reference as if fully set forth herein.

### BACKGROUND OF THE INVENTION

All publications referenced herein are fully incorporated by reference herein, as if fully set forth herein.

1. Field of the Invention

The present invention relates generally to the extraction of information and presentation of related online services, particularly to a client side information extraction application that launches services on an information network, and more particularly in connection with web browsing of the Internet.

2. Description of Related Art

Today's web users navigate through a topology of links and services provided by the publishers of web sites. This navigational topology is very server-centric. For example, a portal like Yahoo or a service like CNN or Amazon will provide its own information to users, as well as links to content on its own site, as well as links it thinks are useful to the user, usually partner websites. Those with the content and the web servers decide what links and services are available to visitors on their site.

Heretofore, attempts had been made to “personalize” the browsing experience (e.g., U.S. Patent Application No. 2002/0130902 and U.S. Patent Application No. 2002/0174230), which attempted to tailor the browsing experience for individual users. Also, early attempts involve customizing the user's experienced based on previous browsing sequences, or “macros”, as in U.S. Patent Application No. 2003/0191729.

Further, previous technology for improving browsers is limited with respect to the scope of services that are offered to the user, and their relevance to the browsing experience. For example, U.S. Pat. No. 6,742,047 presents technology for blocking, or filtering, content based on content. This technology does not use precise, site-specific, data extraction technology in order to identify offending content (moreover, the filtering process does not occur on the client itself). Similarly, U.S. patent application 2004/0139171 presents technology for “pre-loading” documents hyperlinked to the current page as the user browses; while preloading could be viewed as a primitive “service”, there is a fixed, simple means for identifying and extracting the hyperlinks. This does not involve intelligent extraction and semantic labeling of data.

There have also been browser tools that have been commercially released that are built to extract specific, fixed types of data from web pages. For example, EGrabber has released a tool that a user can manually invoke that will specifically attempt to extract names and address from a page, and insert them into an address book (see, U.S. Pat. No. 6,339,795). This type of tool cannot extract arbitrary fields based on the site being browsed; its extraction processes are fixed and support a fixed service. Further, most data extraction schemes related to web browsing, such as the process disclosed in U.S. Patent Application No. 2002/0154162, involve data extraction at the web or content server.

Techniques have been developed by which content and links are offered to the users by way of “wrappers” to improve user web browsing experience. A web page wrapper is a set of instructions that reliably extracts structured information from semi-structured or unstructured documents by taking advantage of patterns present in the document or document's data. (See, for instance, Ion Muslea, Steven Minton, and Craig A. Knoblock: Hierarchical wrapper induction for Semistructured Information Sources, Autonomous Agents and Multi-Agent Systems, 4(½), March 2001.) Some wrappers are specific to a given type of web page, while others profile entities that can be extracted globally or within a given problem domain. For example, a wrapper might identify the author, title and text from an article in a new site, or a product-name, description, and price from a product description page within an e-commerce site. Typically, a wrapper consists of a set of patterns, such as regular expressions, landmark grammars, or hidden Markov models, each of which identifies a field on a page. More complex wrappers may identify a hierarchically organized set of fields on a web page such as a list of names, telephone numbers and addresses on a news site.

A variety of techniques for creating wrappers for web pages have been developed and described in the literature (e.g., Hammer J., Garcia-Molina H., Ireland K., Papakonstantinou Y., Ullman J., Widom J.: Information Translation, Mediation, and Mosaic-Based Browsing in the TSIMMIS System, Proceedings of the ACM SIGMOD International Conference on Management of Data, San Jose, Calif., ACM Press, June 1995; Naveen Ashish and Craig A. Knoblock: Semi-Automatic Wrapper Generation for Internet Information Sources, Proceedings of the Second IFCIS International Conference on Cooperative Information Systems, Kiawah Island, SC, 1997; Naveen Ashish and Craig A. Knoblock: Wrapper Generation for Semi-Structured Internet Sources, Proceedings of the Workshop on Management of Semistructured Data, Tucson, Ariz., 1997, republished in the ACM SIGMOD Record, Special Issue on Managment of Semi-Structured Data, December, 1997; Ion Muslea, Steve Minton, and Craig A. Knoblock: A Hierarchical Approach to Wrapper Induction; Proceedings of the 3rd International Conference on Autonomous Agents, Seattle, Wash., 1999; Kushmerick N.: Wrapper Induction: Efficiency and Expressiveness; Artificial Intelligence, 118(1-2), 15-68, 2000).

In previous work, Minton and his colleagues developed machine learning techniques (both supervised and unsupervised induction methods) for creating wrappers. (See, U.S. Pat. Nos. 6,606,625 and 6,714,941; Ion Muslea, Steven Minton, and Craig A. Knoblock: Active Learning with Strong and Weak Views: A Case Study on Wrapper Induction, Proceedings of the 18th International Joint Conference on Artificial Intelligence (IJCAI-2003), Acapulco, Mexico, 2003; Ion Muslea, Steven Minton, and Craig A. Knoblock: Active+Semi-Supervised Learning=Robust Multi-View Learning, Proceedings of the 19th International Conference on Machine Learning (ICML-2002), pages 435-442, Sydney, Australia, 2002; Ion Muslea, Steven Minton, and Craig A. Knoblock: Adaptive View Validation: A First Step Towards Automatic View Detection, Proceedings of the 19th International Conference on Machine Learning (ICML-2002), pages 443-450, Sydney, Australia, 2002; Ion Muslea, Steven Minton, and Craig A. Knoblock: Hierarchical Wrapper Induction for Semistructured Information Sources, Autonomous Agents and Multi-Agent Systems, 4(½), March 2001. Ion Muslea, Steven Minton, and Craig A. Knoblock: Selective Sampling with Redundant Views, Proceedings of the 17th National Conference on Artificial Intelligence, 2000; Ion Muslea, Steven Minton, and Craig A. Knoblock: Selective Sampling with Naive Co-Testing: Preliminary Results, Proceedings of the ECAI-2000 Workshop On Machine Learning for Information Extraction, Berlin, Germany, 2000; Kristina Lerman, Cenk Gazen, Steven Minton, and Craig A. Knoblock: Populating The Semantic Web, Proceedings of the AAAI 2004 Workshop on Advances in Text Extraction and Mining, 2004; Kristina Lerman, Lise Getoor, Steven Minton, and Craig A. Knoblock: Using the Structure of Web Sites for Automatic Segmentation of Tables, Proceedings of ACM SIG on Management of Data (SIGMOD-2004), 2004; Kristina Lerman, Steven N. Minton, and Craig A. Knoblock: Wrapper Maintenance: A Machine Learning Approach, Journal of Artificial Intelligence Research, 18:149-181, 2003; Kristina Lerman, Craig A. Knoblock, and Steven Minton: Automatic Data Extraction from Lists and Tables in Web Sources, Proceedings of the IJCAI 2001 Workshop on Adaptive Text Extraction and Mining, Seattle, Wash., 2001.)

Wrappers are frequently customized to a particular type of page within a web site. For example, a wrapper that identifies products (including their names, descriptions and prices) from a specific web site may be constructed so that it operates reliably only on pages from that site. Such wrappers typically rely on specific formatting conventions used within that site (e.g., prices may only occur immediately after an “end bold” HTML tag and in a certain font). It is much more difficult to develop wrappers that operate reliably on pages from many sites, although it can be achieved for certain types of fields, such as names and addresses, which can be identified in a site independent fashion.

FIG. 1 illustrates how the user builds a wrapper for an ecommerce site called BookPool.com (which sells books) using the “AgentBuilder” graphical user interface 100 developed by Fetch Technologies, Inc (see, www.fetch.com). The user first declares the data to be extracted from the page through a wizard-like interface. The “Data Declaration Tree” is essentially a simplified XML schema describing the hierarchical structure and attributes of the data targeted for extraction. For example, the wrapper in FIG. 1 extracts specific information about a book, such as its title, ISBN, and price. When this wrapper is executed, it will return an XML document with the structure specified by the tree 102 shown on the left-hand side of the screen.

The user trains the learning system by marking up sample data, in effect, instantiating a Data Declaration Tree on selected sample pages. To do so, the user selects examples of the fields (e.g., price field 104) on a sample page, and drags-and-drops the data on the tree 102 (e.g., at 106), as in FIG. 1. The system then invokes a machine learning algorithm in order to produce a set of extraction rules that will automatically extract the targeted data from all of the pages belonging to the wrapper's page type. The learning system uses all the marked-up sample pages provided-by the user, and generalizes from these to create the data extraction rules. The sophisticated machine learning algorithms used in AgentBuilder are based on years of research at the University of Southern California and Fetch (see, Muslea, Minton & Knoblock and Knoblock, Lerman, et al. references cited above). The ability to learn extraction rules from examples, referred to as wrapper induction, dramatically reduces the amount of human labor required, thereby increasing the scalability of the approach (in terms of the number of agents produced per man-hour).

In the past, most web-based applications of data extraction technology have focused on using wrappers in large server-based applications that harvest large numbers of web pages from web sites. Applications include extracting data from sites for comparision shopping, extracting entities mentioned in news articles, processing resumes, identifying keywords on web sites for web search engines, and so forth.

While the above referenced systems attempted to alleviate certain user inconveniences and improve user experiences, they do not offer the flexibility and intelligence to navigate and extract information based on client side network navigation experience. The present invention is intended to overcome the drawbacks of existing systems, and to address the challenges associated with providing flexible and intelligent network navigation and information extraction.

### SUMMARY OF THE INVENTION

The present invention provides a supplemental, client-centric information extraction application that presents and launches related online services on an information network.

In accordance with one aspect of the present invention, a client-centric tool extracts important data from documents as a user is interacting with an information network, proposing related information services based on the types of data and data values extracted from the current viewed document, by presenting a menu of related information. In one embodiment, the data extraction application comprises a browser plug-in that extracts data from a web page as a user browses the Internet, and provides additional services to the web user as he browses. The present invention provides a means for triggering services that are relevant to the page being browsed without rely on conventional web browsing personalization and/or user-specific profiling.

In accordance with another aspect of the present invention, data extraction wrappers are distributed to the client machines, where they can aid the user as he browses the web. The wrapper supported information extraction process occurs apart from the content server, e.g., on the client machine or a proxy server. The present invention includes a scheme for distributing wrappers to client machines. By distributing data extraction rules to the browser, in effect, makes the browser aware of the content on the page, so that it can suggest appropriate services to the user. The present invention does not need to rely on the web site publisher to do anything; instead, the browser plug-in in accordance with the present invention enables the browser to determine the content on the page through the use of data extraction technology. According to one embodiment of the present invention, wrappers are created by a developer and stored in a central wrapper repository. Wrappers are then distributed to the user's machine, where they are used by the browser plug-in to extract data as the user browses.

Extraction on the client machine is efficient and scalable, and moreover, extracted data can trigger the launching of services, called “hyperservices”, either on the local machine or remote machines, in accordance with a further aspect of the present invention. As a result, the present invention significantly improves the “intelligence” of a web browser, in that it suggests services that are relevant to the data on the page. In particular, since wrappers can semantically label the extracted data based on the position and role of the data the on the page (i.e., in effect, identifying the field that the data fills), the hyperservices can be very precisely targeted. Data is targeted for extraction based on the site and the organization of the page, and relevant hyperservices are suggested by the web browser based on the site and the extracted data.

### BRIEF DESCRIPTION OF THE DRAWINGS

For a fuller understanding of the nature and advantages of the present invention, as well as the preferred mode of use, reference should be made to the following detailed description read in conjunction with the accompanying drawings. In the following drawings, like reference numerals designate like or similar parts throughout the drawings.

FIG. 1 illustrates a user interface tool for building a wrapper.

FIG. 2 is a schematic representation of an information exchange network comprising the Internet, and the information extraction application implemented in accordance with one embodiment of the present invention.

FIG. 3 is a schematic overview diagram illustrating the client-centric information extraction architecture in accordance with one embodiment of the present invention.

FIG. 4 is a schematic diagram illustrating data flow managed by the information extraction application in accordance with one embodiment of the present invention.

FIG. 5 is a schematic diagram illustrating additional details of the browser plug-in shown in FIG. 5, in accordance with one embodiment of the present invention.

FIG. 6 is a schematic flow diagram illustrating an information extraction process in accordance with one embodiment of the present invention.

FIG. 7 is a schematic flow diagram illustrating a hyperservice activation process in accordance with one embodiment of the present invention.

FIGS. 8-15 depict a series of actual screen shots experienced during an example of a web browsing session using the information extraction application in accordance with one embodiment of the present invention.

FIG. 16 is a schematic representation of an information exchange network comprising the Internet, and the information extraction application implemented in accordance with another embodiment of the present invention.

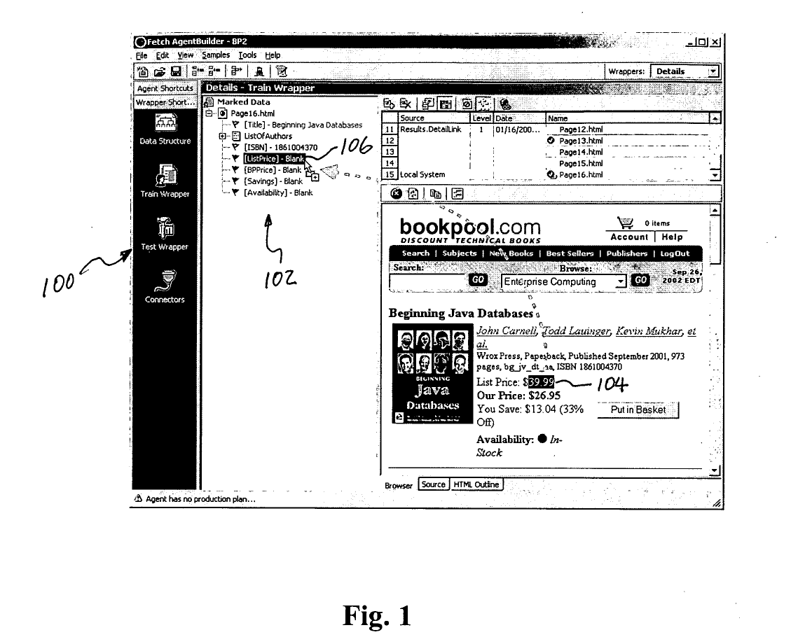

### DETAILED DESCRIPTION OF THE PREFERRED EMBODIMENT

The present description is of the best presently contemplated mode of carrying out the invention. This description is made for the purpose of illustrating the general principles of the invention and should not be taken in a limiting sense. The scope of the invention is best determined by reference to the appended claims.

The present invention is directed to a client-centric information extraction application or tool for presenting to a user on an information network relevant information that is related to the currently viewed document. The present invention can find utility in a variety of implementations without departing from the scope and spirit of the invention, as will be apparent from an understanding of the principles that underlie the invention. “Information” as used herein generally includes commercial and non-commercial information, data and content. It is understood that the information extraction concept of the present invention may be used in connection with different types of information and online services, including without limitation information services and products, information relating to products and services, e-commerce or e-tailing portals, and other basic, value added and premium products and services, which a user may wish to research, shop, transact or otherwise access such information, product and service offerings online or otherwise.

As used in the context of the present invention, and generally, information or content providers generally include any entity that is indirectly or directly presenting information (whether or not relating to products and services), such as an intermediary (e.g., a shopping portal), a reseller or broker of services or a direct provider of products and services, including without limitation suppliers, vendors, resellers, distributors, retailers, manufacturers, contractors, subcontractors, bidders, merchants, job brokers, shopping membership club, and the like. The term “users” and the like, generally refers to any seeker of information, whether or not relating to products and services, and may include without limitation, buyers, purchasers, customers, contractors for subcontracting, resellers or brokers of services, or purchasing agents for end users.

Information Exchange Network

The detailed descriptions that follow are presented largely in terms of methods or processes, symbolic representations of operations, functionalities and features of the invention. These method descriptions and representations are the means used by those skilled in the art to most effectively convey the substance of their work to others skilled in the art. A software implemented method or process is here, and generally, conceived to be a self-consistent sequence of steps leading to a desired result. These steps require physical manipulations of physical quantities. Often, but not necessarily, these quantities take the form of electrical or magnetic signals capable of being stored, transferred, combined, compared, and otherwise manipulated.

Useful client devices for performing the software implemented operations of the present invention include, but are not limited to, general or specific purpose digital processing and/or computing devices, which devices may be standalone devices or part of a larger system, portable, handheld or fixed in location. Different types of client devices may be implemented with the information extraction application of the present invention. For example, the information extraction application of the present invention may be applied to desktop client computing device, portable computing device, or hand-held devices (e.g., cell phones, PDAs (personal digital assistants), etc.) The client devices may be selectively activated or configured by a program, routine and/or a sequence of instructions and/or logic stored in the devices. In short, use of the methods described and suggested herein is not limited to a particular processing configuration.

The information network accessed by the information extraction application in accordance with the present invention may involve, without limitation, distributed information exchange networks, such as public and private computer networks (e.g., Internet, Intranet, WAN, LAN, etc.), value-added networks, communications networks (e.g., wired or wireless networks), broadcast networks, and a homogeneous or heterogeneous combination of such networks. As will be appreciated by those skilled in the art, the networks include both hardware and software and can be viewed as either, or both, according to which description is most helpful for a particular purpose. For example, the network can be described as a set of hardware nodes that can be interconnected by a communications facility, or alternatively, as the communications facility, or alternatively, as the communications facility itself with or without the nodes. It will be further appreciated that the line between hardware and software is not always sharp, it being understood by those skilled in the art that such networks and communications facility involve both software and hardware aspects.

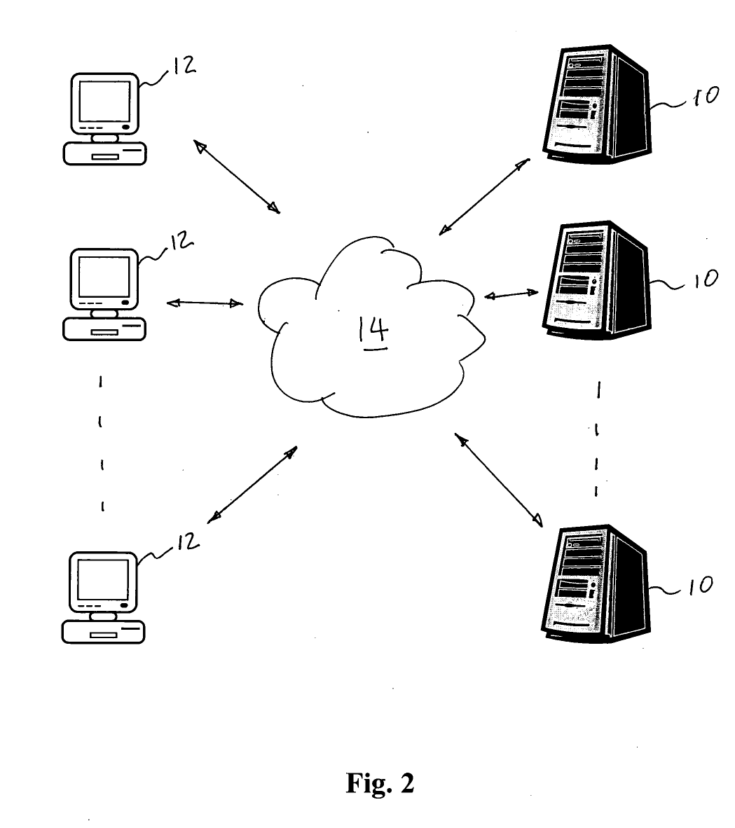

The Internet is an example of an information exchange network including a computer network in which the present invention may be implemented, as illustrated schematically in FIG. 2. Many servers 10 are connected to many clients 12 via Internet network 14, which comprises a large number of connected information networks that act as a coordinated whole. Details of various hardware and software components comprising the Internet network 14 (such as servers, routers, gateways, etc.), the server 10 and the clients 14 are not shown, as they are well known in the art. Further, it is understood that access to the Internet by the servers 10 and clients 12 may be via suitable transmission medium, such as coaxial cable, telephone wire, wireless RF links, or the like, and tools such as browser implemented therein. Communication between the servers 10 and the clients 12 takes place by means of an established protocol. As will be noted below, the information extraction application of the present invention may be configured in or as one of the clients 12, which is accessible by a user to navigate and extract information from one of the servers 10.

This invention works in conjunction with existing technologies, which are not detailed here as it is well known in the art and to avoid obscuring the present invention. Specifically, methods currently exist involving the Internet, web based tools and communication, and related methods and protocols.

Process Overview

To facilitate an understanding of the principles and features of the present invention, they are explained with reference to its deployments and implementations in illustrative embodiments. By way of example and not limitation, the present invention is described in reference to examples of deployments and implementations relating to online information providers, and more particularly in the context of the Internet environment. Reference is made to an “AUB” (an acronym for “As-U-Browse”) product in accordance with one embodiment of the present invention, which is a product developed by Fetch Technologies, Inc., the assignee of the present invention.

Overview of the AUB Architecture

AUB tool is based on a supplemental, client-centric data extraction architecture, which provides for presentation of related online services to the user and launching of such services. The central idea of AUB is to extract important data from web pages as a user is browsing the Web, proposing related information services based on the types of data and data values extracted, and invoking those information services for the user. AUB achieves this functionality by distributing data extraction rules to the browser, in effect, making the browser aware of the content on the page, so that it can suggest appropriate services to the user. Comparing to the “semantic web” approach, in which content on a web site is described in a high level, semantic language and it is commonly assumed that web site publishers will “mark up” the content on their sites to describe the content at a semantic level, AUB, in contrast, does not rely on the web site publisher to do anything. Instead, AUB is a browser plug-in that enables the browser to determine the content on the page through the use of data extraction technology.

For example, when an AUB user sees the same page on Yahoo or CNN or Amazon, but as he browses, the browser plug-in of the AUB tool extracts data from the currently viewed document and presents related information services to the user. Thus, the AUB tool provides a means for additional services to be provided to web users as they browse the Internet.

One of the differences of the AUB application compared to most previous extraction applications is that the extraction process occurs apart from the content or information server, e.g., on the client machine in accordance with one embodiment of the present invention. The extraction process may also be implemented in a proxy server. AUB effectively provides a means for triggering services that are relevant to the page being browsed, without relying on browsing personalization and/or user-specific profiling.

To enable this, AUB includes a scheme for distributing wrappers to client machines where they can aid the user as he browses the web. Extraction on the client machine is efficient and scalable, and moreover, enables services (“hyperservices”) to be triggered directly on the client machine. AUB thus significantly improves the “intelligence” of a web browser, in that it suggests services that are relevant to the data on the page. In particular, since wrappers can semantically label the extracted data according to specific fields, context or roles, which the data implicitly fills on the page, the hyperservices can be very precisely targeted. For instance, if the user is booking an airline flight, a site-specific wrapper can distinguish between the origin and destination airports (based on their position in the text), and as a result, activate one hyperservice that offers parking information about the origin airport, and another hyper service that suggests hotels close to the destination airport. In general, the AUB approach is distinguished by the fact that precise, site specific data to be targeted for extraction, and by the fact that content-specific, site-specific hyperservices are suggested by AUB in response to the extracted data.

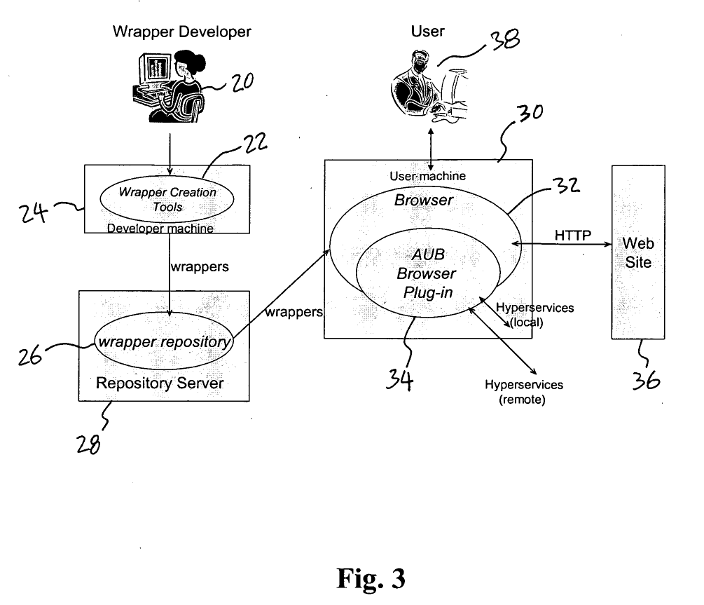

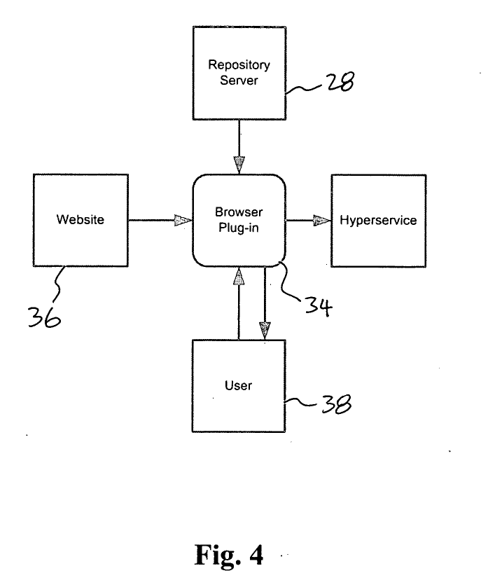

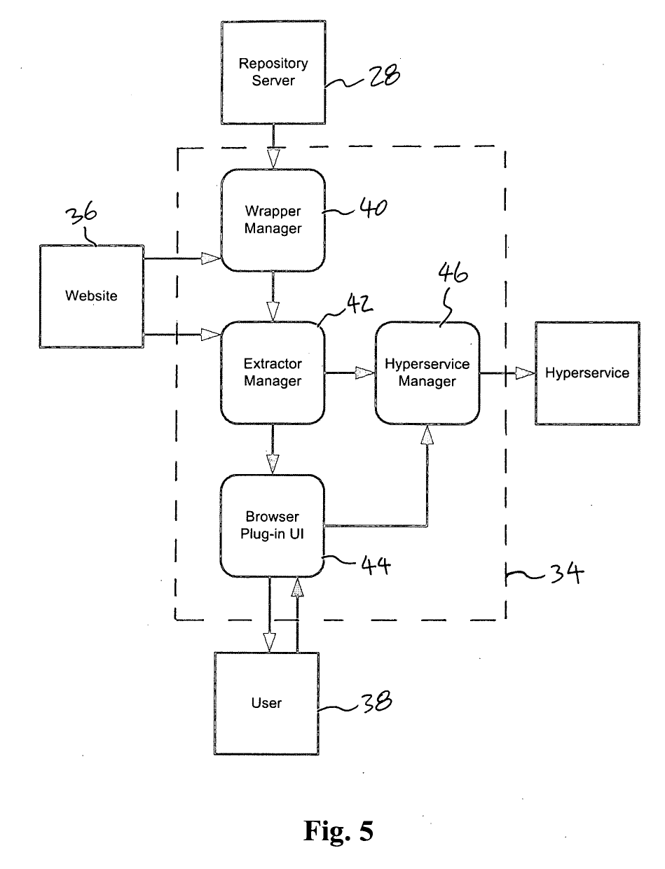

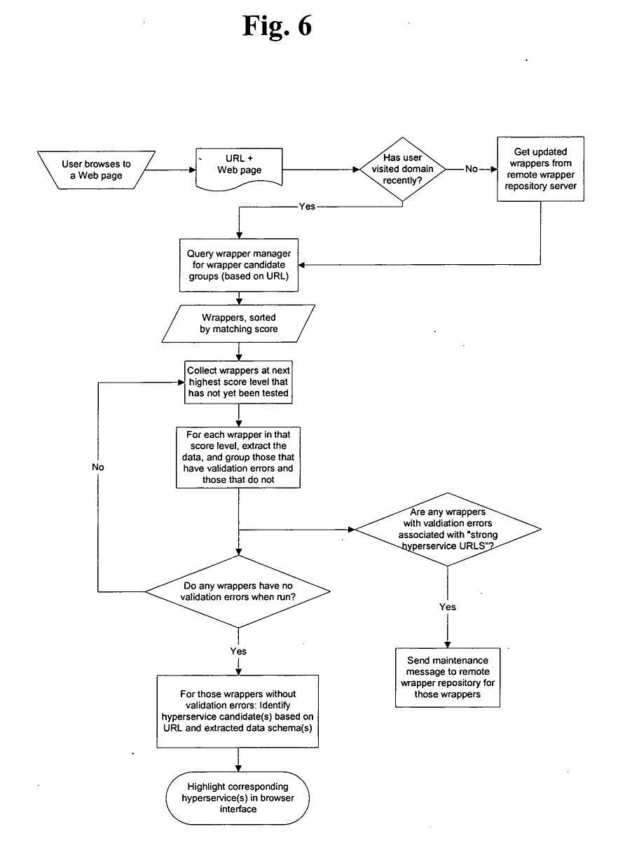

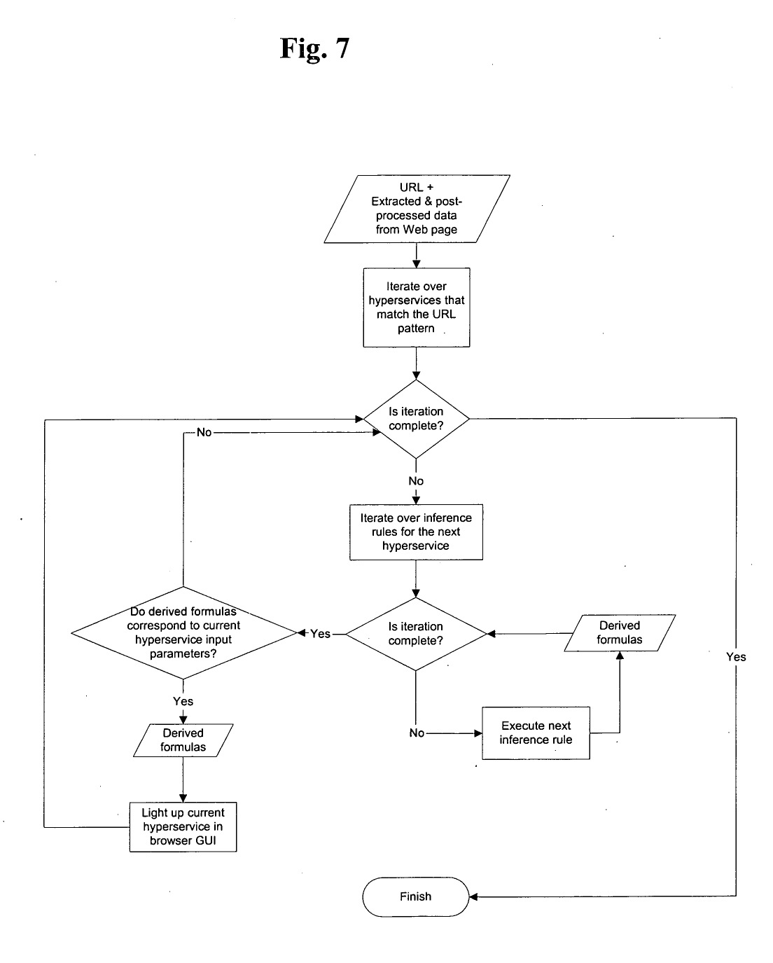

As shown in FIG. 3, in accordance with the AUB application, wrappers are created by a developer 20 using a wrapper creation tool 22 at that developer machine 24, and stored in a central wrapper repository 26 at a repository server 28. The developer machine 24 and the repository server 28 could be one of the clients 12 and servers 10, respectively, in FIG. 2. Wrappers are then distributed to the user's machine 30 (which may be one of the clients 12 in FIG. 2), where they are used by AUB browser plug-in 34 to extract data as the user 38 browses a website 36 (e.g., made available at one of the servers 10 in FIG. 2) using browser 32. Extracted data can trigger the launching of services, called “hyperservices”, either on the local machine 30 or remote machines (not shown, which may be one of the servers 10 in FIG. 2). FIG. 4 shows the top-level process data flow, and FIG. 5 shows one embodiment of the functional components of the browser plug-in 34. FIG. 6 presents a flowchart that shows the overall process flow in AUB, and FIG. 7 more specifically presents a flowchart that shows the process flow relating to hyperservice activation. The following sections further describe these processes.

Wrappers in AUB

In accordance with one embodiment if the present invention, AUB employs wrappers that are induced by the Fetch AgentBuilder system. However, in general, any information extraction technology can be used as the basis of the wrappers that extract information for AUB. Depending on the particular application, it may be required that the wrappers efficiently extracts labeled data (e.g., company names, addresses, phone numbers) that represent the values of fields on the web page being browsed. As will be discussed below, some of the wrappers used in AUB may be site-specific.

The extraction rules for the AUB wrappers are represented using a “landmark grammar” (see the above-referenced publications authored by Muslea et al.). An AUB wrapper also includes post-processing rules for validating and transforming the extracted data. Specifically, validation rules test that the extracted data meet certain criteria. For example, validation rules can check that a field is nonempty, or does not contain HTML tags, or matches a regular expression (e.g., a three digit number followed by a hyphen followed by a for digit number). Transformation rules are used to normalize, (i.e., standardize) the extracted data. For example, transformation rules may remove HTML tags, or convert a string to lowercase, or remove comma within a large number. Transformation rules may be expressed using a pattern substitution expression, such as those found in standard regular expression libraries.

In AUB, each wrapper is also associated with a URL pattern that allows the user to specify the pages/sites that the wrapper can extract from. A URL pattern, in one embodiment of the AUB, is a regular expression that specifies a set of URLs.

In an optional extension of this scheme, arbitrary weights may be assigned to various component in the URL (e.g., domain name, server name, filename, parameter name, etc.), so that a more fine-grain pattern match may be specified. A score for a URL can then be calculated by summing the weights of the components that match a URL pattern. Such patterns are referred to here as weighted URL patterns.

When a wrapper is built for a site, the Fetch Agent Builder enables a developer to build an associated URL pattern, so that the developer can specify the URLs of the pages that the wrapper should extract data from. For example, if a wrapper is developed to extract book titles and prices from a book selling site, then the URL pattern associated with that wrapper should match the URLs of the pages on that site that describe books. As will be discussed, URL patterns enable the AUB browser plug-in 34 to identify wrappers that may be relevant to a page. Thus, it is not necessary that a URL pattern match only pages that the wrapper can extract from, but “tighter” (i.e., more specific) patterns will result in better performance.

In some cases, a URL pattern may be “exact” in that it may specify precisely those pages on which the wrapper should be able to extract. That is, if the URL pattern matches, then the wrapper should be able to extract valid data. These patterns are referred to here as “strong URL Patterns”. As described later, if a URL pattern is strong, it can be useful for identifying “broken” wrappers. Occasionally, a wrapper breaks because a site changes its formatting, and therefore the wrapper can no longer correctly extract data.

For the purposes of the present disclosure, an extractor is defined as a component that extracts data from a web page using a wrapper. The input to an extractor is a wrapper and a web page. The output is structured data, e.g., a set of named fields described in XML.

Browser Plug-in Overview

Referring to FIG. 4, the browser plug-in comprises the following functional components:
(a) Wrapper manager 40; which manages the local wrapper cache, retries wrappers from the Repository Server as necessary, and supplies wrappers to the extractor manager 42.
(b) Extractor manager 42; which takes wrappers from the wrapper manager 40, performs URL matching, attempts to extract data from a web page, and stores the results in a temporary extracted data cache, which feeds into the hyperservice manager 46.
(c) Hyperservice manager 46; which accepts recently extracted data from the temporary extracted data cache, linking it to hyperservices stored in the hyperservice cache, which it feeds to the browser plug-in UI for presentation to the user. The hyperservice manager 46 optionally retrieves hyperservices from a hyperservice repository server (which may be made available at a remote server 10) or other sources.
(d) Browser plug-in UI; which presents hyperservices to the user. If the user selects a hyperservice, the hyperservice, descriptive information, parameters and associated wrapper-extracted data are presented. The user selects the desired data and the hyperservice manager 46 invokes the hyperservice.
   Distributing and Executing Wrappers in AUB

Referring back to FIG. 3, in the AUB architecture, wrappers are created for a set of sites, individually compressed and encoded, and stored in a central wrapper repository 26 on a server 28. The wrappers are then distributed via the Internet to each client machine 30 and stored locally in a wrapper cache. When wrappers are downloaded from the repository server 28 and stored in the local wrapper cache, associated URL Patterns are also downloaded and stored. Referring to FIG. 4 and FIG. 5, a client-site component of AUB called the wrapper manager 40 coordinates the process of downloading and storing the wrappers and the associated URL patterns on the user machine 38. The wrapper manager 40 may be configured so that it downloads the wrappers from the repository server 28 either in batch or incrementally. In batch mode, the wrapper manager 40 initially downloads the full set of wrappers and periodically checks the repository server 28 for updates. In an incremental approach (more fully described later below in reference to the example of the web browsing session), each time the browser visits a new site, or a site that has not been visited with a certain period of time, the wrapper manager 40 checks with the repository server 28 for updated wrappers for that site.

Once the wrappers are stored locally on the user machine 30, they can be used to extract specific types of information on a web page, as the user 38 browses using the browser 32, and interacting with the browser plug-in 34 via the browser plug-in UI 44, which is integrated into the browser 32 as illustrated later below. An AUB extractor manager 42 communicates with the wrapper manager 40 and the website 36. The AUB extractor manager 42 identifies which wrappers for a given domain to use by first selecting all wrappers from that domain as provided by the wrapper manager 40, then comparing the URL of the current page with the URL pattern associated with each. The set of wrappers with matching URL patterns are selected, and each wrapper is executed in turn. If the wrapper's extracted values are all valid, according to its validation rules, then the results are retained, otherwise they are discarded. (If the URL patterns are weighted, then the wrappers may be first sorted, using the weights associated with each token contained in the pattern to calculate the total score for the wrapper. Wrappers with the highest scores are tried first. Once a wrapper returns results that are all valid, then any wrapper with a lower score is discarded.) FIG. 6 illustrates the flow process of the functions of the wrapper manager 40 and extractor manager 42.

Hyperservices

Once a set of fields has been extracted from a web page by one or more wrappers, AUB identifies a set of services that match the extracted data, as shown towards the end of the process flow illustrated in FIG. 6, leading to the services resulting from the hyperservice activation process illustrated by the process flow in FIG. 7. These AUB-triggered services are referred to herein as hyperservices.

An example of one possible hyperservice is a service that inserts events into the user's Personal Information Manager (PIM). Such a service could be invoked by the user, for instance, when booking an airline ticket on the web, so that the itinerary can be automatically inserted into the user's Outlook calendar. Another example of a hyperservice would be a service that automatically displays targeted information or advertisements to the user as he browses, based on the content extracted by the browser. For instance, as the user is browsing an airline site to select a flight, the hyperservice could display information about the on-time performance of the flights he is browsing. Finally, as detailed below, a third example of a type of hyper service is one that executes a GET or POST against a website, so that the user can visit and relevant page on another web site. In such a scenario, the user might be visiting an online store and considering whether to buy an espresso maker, and a hyperservice might enable the user to jump directly to a page on a comparison shopping site containing prices of competing products.

In general, hyperservices can be any local service on the client machine, as well as Internet-available services, including websites (invoked via HTTP GET and POST) web services (via SOAP, for example), or by using an intermediary such as a Fetch agent (see, www.fetch.com; Sorinel I. Ticrea, Steven Minton: Inducing Web Agents: Sample Page Management. Proceedings of the International Conference on Information and Knowledge Engineering, IKE'03, Jun. 23-26, 2003, Las Vegas, Nev., USA, Volume 2; and J. Beach, S. N. Minton, and W. E. Rzepka: A Software Agent Infrastructure for Timely Information Delivery, IASTED International Conference on Knowledge Sharing and Collaborative Engineering, KSCE 2004), which interacts with a website, returning structured data. In case the hyperservice returns XML or other structured data, the hyperservice declaration can contain presentation information or reference to a style sheet.

From a top-level perspective, the AUB browser plug-in 34 taps into the user's web browser 32 so it knows when the browser 32 migrates to a new page. Each time it does, the browser plug-in 34 checks (if need be) with the repository server 28 for new or updated wrappers. The browser plug-in uses wrappers, if they exist, to extract data from the current web page. If any hyperservices are identified that can use the wrapper-extracted data, the browser plug-in 34 presents those hyperservices to the user. If the user selects a hyperservice and then selects hyperservice parameters from the wrapper-extracted data, the browser plug-in invokes the hyperservice.

URL Patterns and Hyperservice Activation

As with a wrapper, each hyperservice is associated with a URL pattern, so that hyperservices are only considered relevant on pages that match their URL pattern. In addition, hyperservices are only triggered when the data extracted from a page is relevant to that hyperservice. Specifically, each hyperservice is associated with a set of input parameters. When a wrapper extracts data from a page, the system attempts to match the extracted data against the input parameters of each relevant hyperservice, and if the match is successful, the hyperservice is activated, coordinated and processed by a hyperservice manager 46. For example, a hyperservice that inserts events into the user's calendar would take as input parameters the date and time of the event, as well as the event description, all of which would need to be extracted by a wrapper in order for the hyperservice to be triggered.

The process of matching the extracted and input data types can be simple, e.g., a simple name match. For example, the hyperservice may require a date and time as input, in which case the extracted data must include a data and time. But more generally, the matching process may involve a series of steps where inference rules are executed.

In effect, the inference rules provide a layer that maps the ontology used by the wrappers to the ontology used by the hyperservices. For instance, the wrapper may extract a year, month and day, and a series of inferences may be required to concatenate and transform these into a date that the hyperservice can take as input. Or, for another example, the wrapper may extract an “airport name”, but if the hyperservice requires an “international airport name”, an inference rule may be required to determine if the extracted airport is in fact an international Airport. The inference rules execute on the client machine, but notably, the execution of a rule may involve calling an arbitrary function (as supported by most rule languages, such as Prolog), which in turn may contact a remote server or data source.

Formally, inference rules enable one to prove that a set of formulas implies a second set of formulas. In AUB, the first set of formulas corresponds to the data produced by the wrapper, i.e., each datum extracted and post-processed by the wrapper corresponds to a formula. The inference-rules operate on these formulas, and in effect, generate a second set of formulas that logically follow from the first set, and “match” the input parameters required by the hyperservice. This is a standard logic programming approach.

The hyperservice cache is local cache on the client that stores information about each hyperservice the user has subscribed to, including its definition (i.e., a reference to the code that implements the service), URL patterns, parameters, and any inference rules required to map extracted data into the parameters.

The invocation of a hyperservice is coordinated by the hyperservice manager 46. Referring to FIG. 7, the process proceeds as follows. When data is extracted by an AUB wrapper, the hyperservice manager looks up the possible hyperservices that are relevant. This is accomplished by checking each of the URL patterns associated with the set of available hyperservices. If the URL pattern matches, the system checks to determine if the extracted data types match the input parameters, which may involve executing a series of inference rules. If the input parameters can be matched, or inferred, AUB triggers or activates the hyperservice, which may be indicated (e.g., highlighted) by the browser plug-in UI 44. Thus, a hyperservice is activated if its URL pattern matches the current page and the extracted data types match the hyperservice's input parameters' data types.

Hyperservice Presentation

The method of interacting with the user to enable him to select which activated hyperservices to execute, and the presentation of the results, will vary with the choice of services offered. In the embodiment described later in the example, hyperservices are organized into a menu to present them in an organized fashion to users by way of the browser plug-in UI 44. In the illustrate embodiments of the browser plug-in UI 44, it comprises a toolbar that contains icons and text representing top-level hyperservice ontology categories, and pop-up windows depicting information and allowing user selection of information for the hyperservice to be invoked by the user. Hyperservices are inactive when no extracted data is present that can be used to invoke it. When all the hyperservices in a category are inactive, that category's icon and text on the toolbar are visually marked as inactive. In this way, only active hyperservices attract a user's attention.

In another embodiment, another browser plug-in user interface may involve a browser panel (e.g., to the left or bottom of the main browser window) to present a menu of active hyperservices to the user.

Wrapper Maintenance

As noted previously, when a site changes its formatting, it may result in a wrapper “breaking”, in that it can no longer correctly extract data. If a wrapper breaks, it will normally result in validation errors. That is, the data extracted by the wrapper will cause one or more validation rules to fail.

If a wrapper is associated with a strong URL pattern, then it should never generate validation errors if the URL pattern matches the current page. For this reason, if a wrapper has a strong URL pattern, it can be used to identify broken wrappers that need to be fixed. Thus AUB includes the option for sending notification messages back to a central server when a wrapper with a strong URL pattern generates validation errors. Once these notification messages are received, the wrapper can be fixed, and redistributed back to the AUB client machines (following the normal mechanism).

Example of Browsing Session

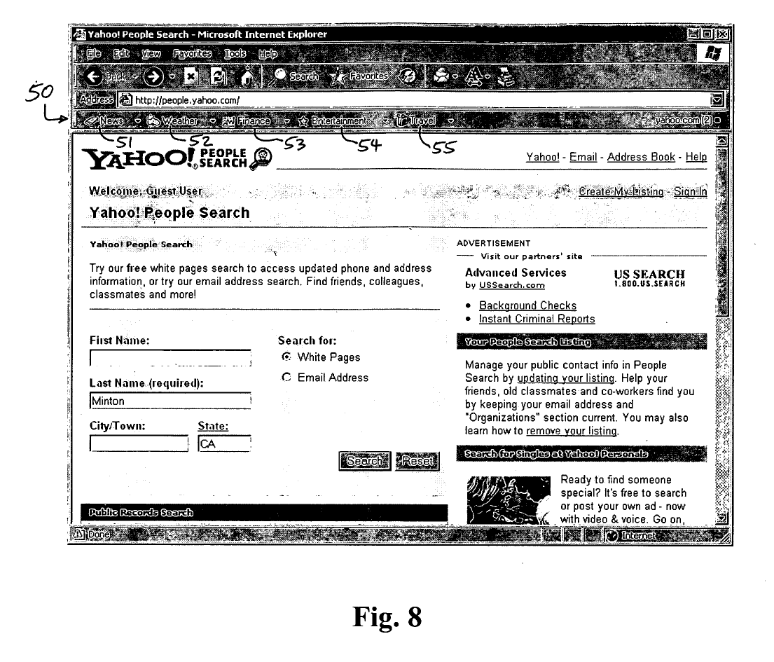

Referring to the series of screen shots shown in FIGS. 8-15, the following describes a walk-through of a browsing session in accordance with one embodiment of the AUB technology that has been implemented, showing how the technology creates a new experience for the web user. AUB extracts important data from web pages as a user is browsing the web, proposing related information services based on the types of data and data values extracted, and invoking those information services for the user.

The walk-through begins at a point where the user has previously downloaded and installed the AUB browser toolbar 50, as shown in FIG. 8. The user has navigated to people.yahoo.com. When the user is beginning to navigate to a domain (such as Yahoo.com) that the user either has never visited or has not visited for a certain period of time, AUB will check with the repository server to see if the local wrapper cache needs to be updated. When the page has completed loading in the browser, AUB checks the local wrapper cache, and then determines if any wrappers are appropriate candidates for extraction, based on the URL of the page and the URL pattern of the wrappers. Assume that the cache is current (so AUB does not need to retrieve new wrappers from the wrapper repository), and that there are two wrappers whose URL pattern matches the URL of the current page. AUB populates a local extracted data cache with all data extracted from the current page. In this case, though two wrappers exist for the yahoo.com domain and were tried in the background, no data was extracted. Note the AUB toolbar 50 (here located beneath the Address bar just above the main browser window) has a number of icons 51 to 55 for categories of hyperservices that are grayed out, indicating that either no data was extracted from this page (as in this case) or no hyperservices exist for the extracted data.

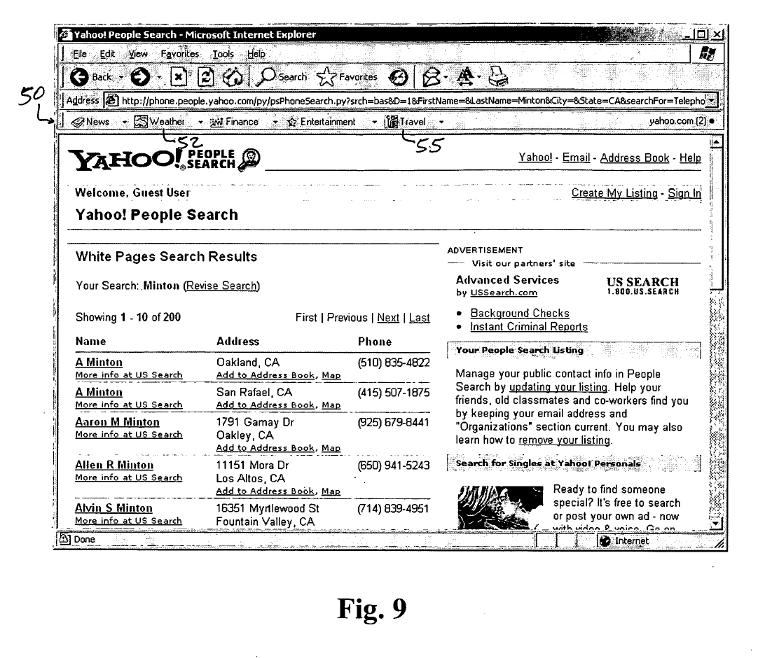

Next, the user searches for people named “Minton” in California by typing “Minton” into the text box on the Yahoo page shown in FIG. 8 and clicking the “search” button. The Yahoo White Pages Search Results returns 200 Mintons, as shown in FIG. 9. As explained previously, AUB looks at the local extracted data cache to see if any data has been extracted. If data has been extracted successfully using any of the wrappers in the local wrapper cache for the current domain, it will attempt to match that data with hyperservices. If there are wrapper-extracted data matching any hyperservices in the local hyperservice cache, the hyperservice category icons on the browser toolbar that contain the matching hyperservices are highlighted. In this case there are two wrappers for Yahoo, and one extracted city names from the Address column of the search response table. The wrapper field name is “city” and there are several hyperservices in Weather and Travel categories that can be invoked using “city” as input (amongst many others). Those two category icons 52 and 55 for Weather and Travel are highlighted on the toolbar 50, as shown in FIG. 9.

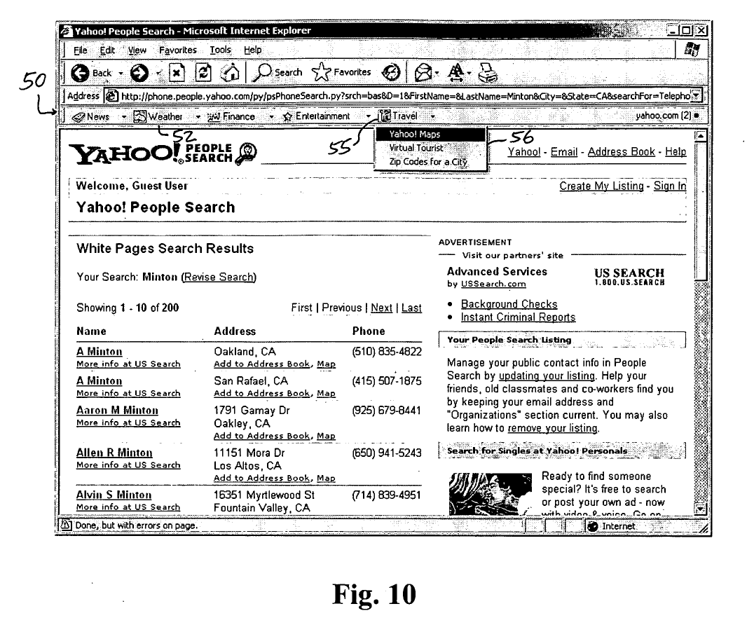

As shown in FIG. 10, the user selects the icon 55 for Travel and selects one of the enabled hyperservices: Yahoo! Maps. Note that within the Travel hyperservice category, there are three registered hyperservices: “Yahoo! Maps”, “Virtual Tourist”, “Zip Codes for a City” as shown in the drop-down list box 56. Only the hyperservices matching the data extracted from the page are enabled. In this case all three hyperservices are enabled. Hyperservices that are not enabled would-be grayed out on the list (not applicable in this particular example).

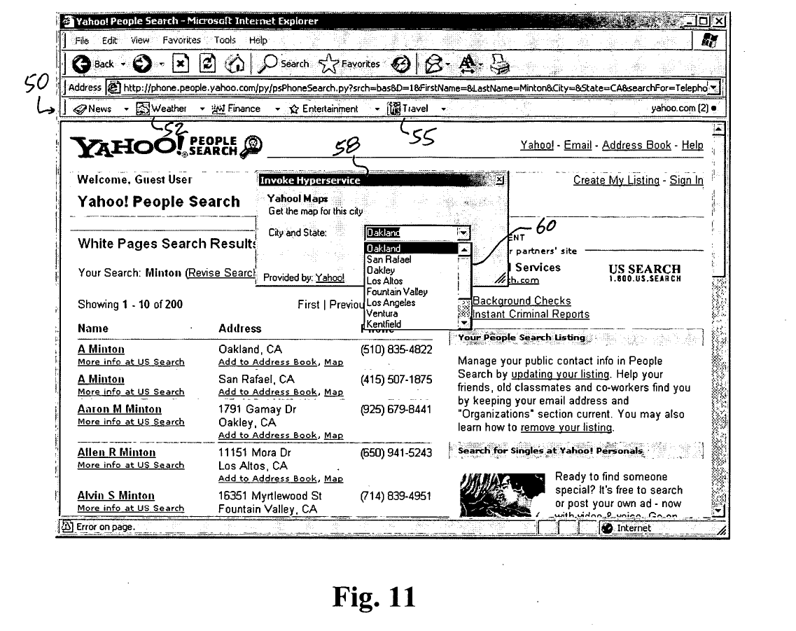

Once the user selects a hyperservice, such as “Yahoo! Maps” in FIG. 10, the user is presented with a pop-up invocation window 58 depicting a short description of the hyperservice and prompted to provide the parameters necessary to invoke the hyperservice, as in FIG. 11. The name of the hyperservice, its description, information on parameters, and a link to the provider are all stored in the hyperservice cache. Data extracted from the current Yahoo White Pages Search Results page populates the drop-down list box 60 on the invocation window 58, as shown in FIG. 11. Note that the city names in the drop-down list box 60 are taken directly from the City field in the Address column of the web page. In the general case, more than one input parameter may be required, in which case more than one drop-down list would appear.

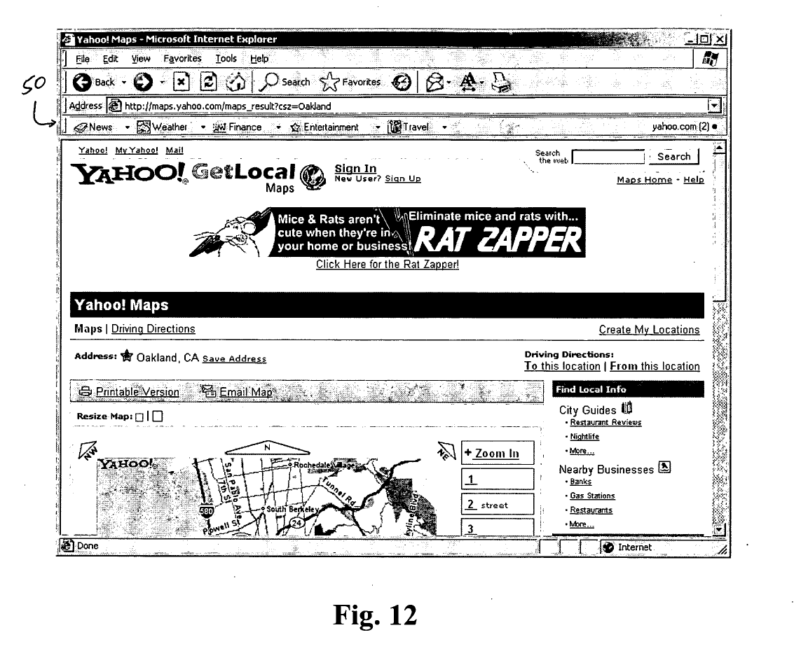

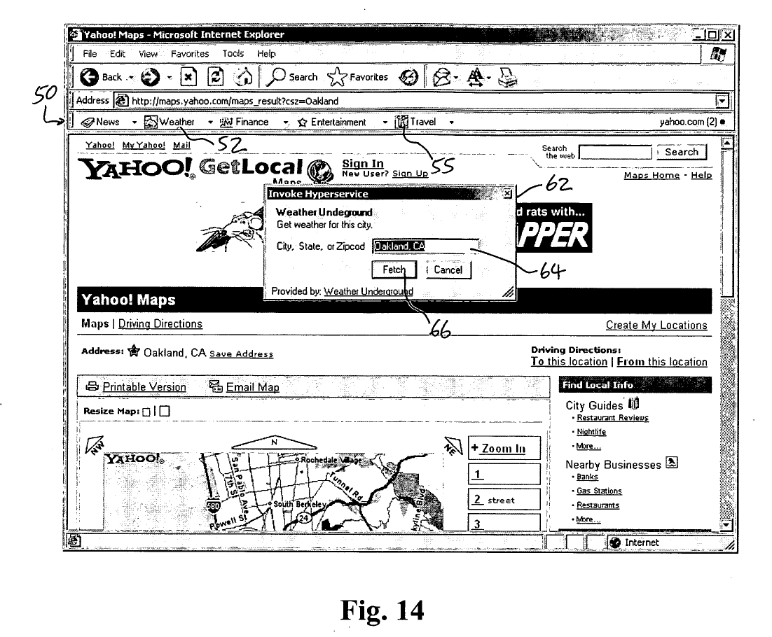

In FIG. 11, the user selects Oakland and clicks the Fetch button provided in the pop-up invocation window 58 (the Fetch button is hidden from view in FIG. 11, under the drop-down list box 60, but can be seen in the pop-up invocation window 62 for another hyperservice as shown in FIG. 14). The Fetch button activates the Fetch agent to execute the hyperservice invoked by the user. AUB invokes the hyperservice using Oakland as the parameter. The hyperservice response page is shown in the browser in FIG. 12. In general, hyperservices can be implemented using HTTP GETs, POSTs, SOAP, or other remote procedure calls. In this case, the hyperservice is simply an HTTP GET, and the response page is exactly the same as if someone had gone to Yahoo Maps and typed in “Oakland” into a search.

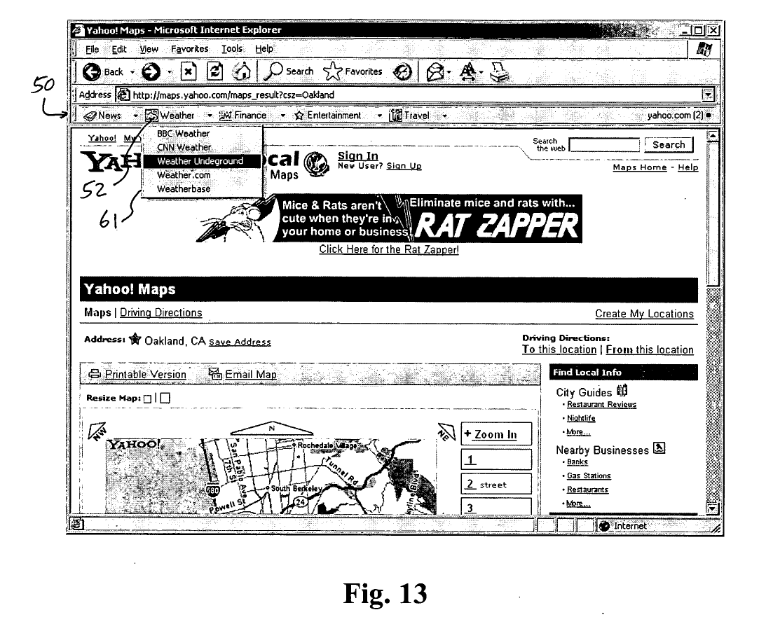

Once a hyperservice response page has loaded in the browser, the cycle begins again, and AUB tries to find wrappers that will work for this page, extract the data, match hyperservices and propose those to users. In FIG. 12, notice that the AUB browser toolbar 50 again has two categories of hyperservices that are still highlighted, Weather and Travel, indicating that hyperservices in these two categories are again relevant—this time on the Yahoo! Maps page in FIG. 12. In FIG. 13, the user decides that he will check Weather Underground for weather on Oakland, by clicking icon 52 on the AUB browser toolbar 50 and selecting from the drop down list box 61.

As shown in FIG. 14, Oakland, Calif. is the only value extracted from the current web page. Note that in this case since only one extracted value maps into a parameter, so a simple pop-up invocation window 62 will appear, having a simple text box 64 populated with the wrapper-extracted data (rather than appearing in a drop down list). The user clicks the Fetch button 66 and AUB invokes the hyperservice using Oakland, Calif. as the parameter.

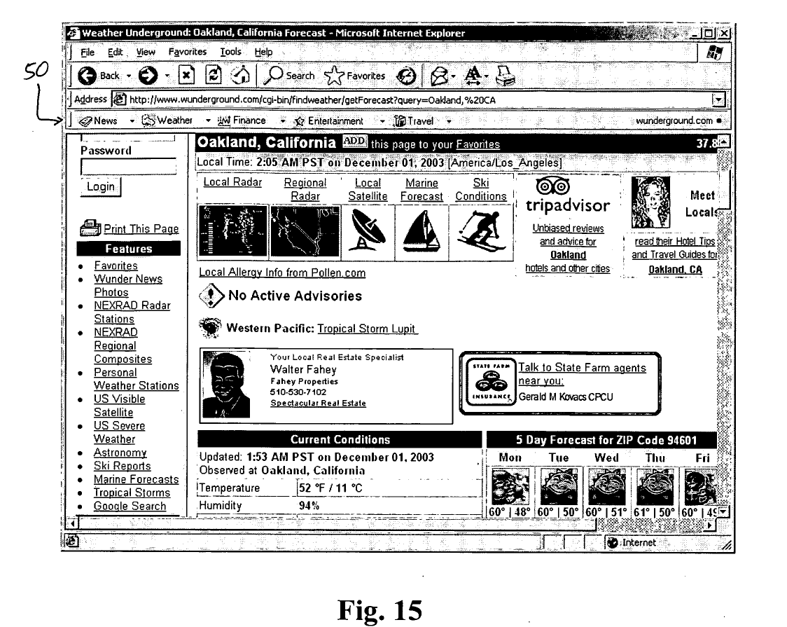

In FIG. 15, the hyperservice response screen appears in the browser. There are no wrappers that work for this page, so no hyperservices are activated, and hence no hyperservice category buttons are enabled in the AUB browser toolbar 50.

### Alternate Embodiment

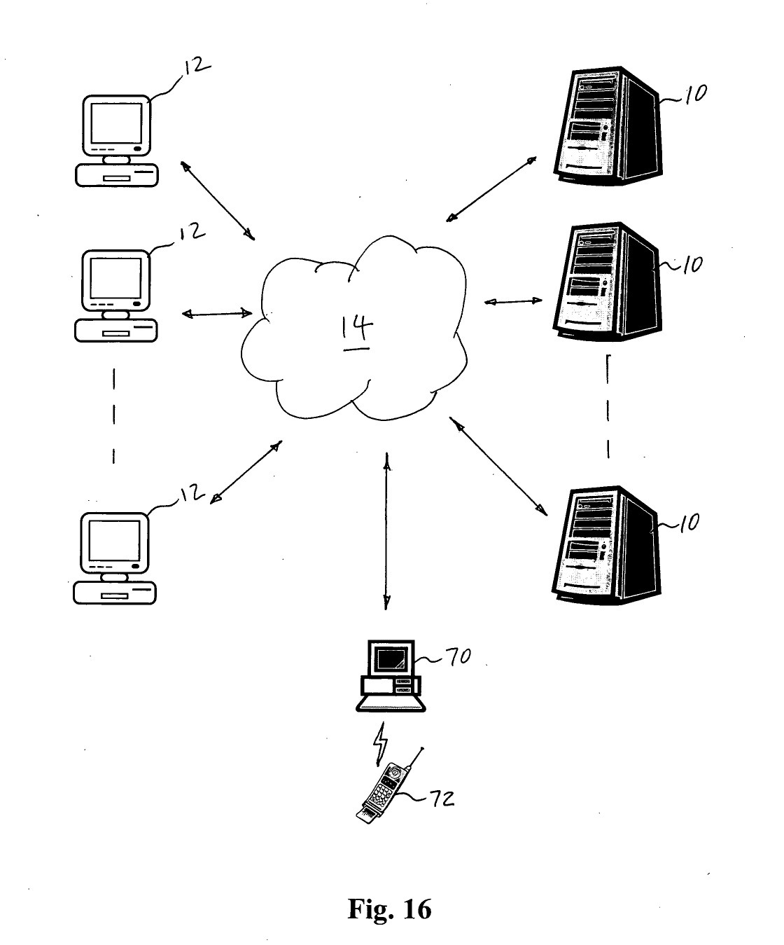

Referring to FIG. 16, one alternate embodiment to the preceding embodiment described above removes the need for a browser plug-in in the client device 72, instead placing the AUB functionality on a proxy server 70. In this case, a company or Internet Service Provider (ISP) extracts data centrally, and attaches to or annotates documents with related hyperservice information. Extraction and hyperservice invocation occur as they were explained above, except that the functionality is hosted on a proxy server 70 (which may also be one of the client 12 and/or server 10) that is remote with respect to the user (e.g., a hosting server maintained by an application service provider (ASP) for remote access by the user using a remote device 72 such as a cell phone or wireless PDA). (It is, however, understood that in an alternate embodiment, the proxy server and the content server may occupy the same physical device, but having distinct functions as noted above). In the context of this embodiment, the proxy server 70 is a “client” with respect to the content and web servers 10. The AUB function of the proxy server is distinct and separate from the function of typical content or web servers 10 that provide content for web browsing to the user. In other words, the proxy server 70 is merely an extension of the user device 72. This architecture provides comparable level of information extraction retrieval functions for wireless devices that do not have significant memory or extensibility.

The process and system of the present invention has been described above in terms of functional modules in block diagram format. It is understood that unless otherwise stated to the contrary herein, one or more functions may be integrated in a single physical device or a software module in a software product, or one or more functions may be implemented in separate physical devices or software modules at a single location or distributed over a network, without departing from the scope and spirit of the present invention.

It is appreciated that detailed discussion of the actual implementation of each module is not necessary for an enabling understanding of the invention. The actual implementation is well within the routine skill of a programmer and system engineer, given the disclosure herein of the system attributes, functionality and inter-relationship of the various functional modules in the system. A person skilled in the art, applying ordinary skill can practice the present invention without undue experimentation.

While the invention has been described with respect to the described embodiments in accordance therewith, it will be apparent to those skilled in the art that various modifications and improvements may be made without departing from the scope and spirit of the invention. For example, the information extraction application can be easily modified to accommodate different or additional processes to provide the user additional flexibility for web browsing. Accordingly, it is to be understood that the invention is not to be limited by the specific illustrated embodiments, but only by the scope of the appended claims.

1. A method for user interaction with an information network, comprising the steps of:
providing a user interface by which a user interacts with the information network, the user interface displaying to the user a plurality of pages of information retrieved from the information network for viewing; and
providing an application operatively coupled to the user interface, which application extracting data from currently viewed page of information, and causing the user interface to display related information based on the extracted data.

2. The method as in claim 1, wherein the application extracts data by a set of predetermined instructions that extracts structured information from semi-structured or unstructured information.

3. The method as in claim 2, wherein the predetermined set of instructions are represented by a wrapper.

4. The method as in claim 3, further comprising the steps of:
storing a plurality of wrappers, each created and associated with at least one information source; and
the application retrieving at least one wrapper that is associated with the information source that provides the currently viewed page.

5. The method as in claim 4, wherein the application retrieves the at least one wrapper associated with the currently view page by taking into consideration weighted association of identity data of the information source that provides the currently viewed page.

6. The method as in claim 1, wherein the related information includes at least one related online service that the user can invoke.

7. The method as in claim 6, wherein the application determines at least one input parameter required by the related online service based on the extracted data.

8. The method as in claim 7, wherein the at least one input parameter is determined by applying inference rules to the extracted data to match the at least one input parameter required by the related online service.

9. The method as in claim 6, further comprising the step of the application launching the related online service upon invoking by the user.

10. The method as in claim 1, wherein the application is supported in at least one of a client device and a proxy device remote to the client device.

11. The method as in claim 1, wherein the information system is the Internet, the user interface is a browser, and the application is a browser plug-in.

12. A system for user interaction with an information network, comprising:
a user interface by which a user interacts with the information network, the user interface displaying to the user a plurality of pages of information retrieved from the information network for viewing; and
an application operatively coupled to the user interface, which application extracting data from currently viewed page of information, and causing the user interface to display related information based on the extracted data.

13. The system as in claim 12, further comprising a repository storing a plurality of wrappers for data extraction, from which the application can retrieve a wrapper to extract data from the currently viewed page of information.

14. The system as in claim 13, wherein the application comprises:
a wrapper manager interfacing with the repository to retrieve at least one wrapper associated with the currently viewed page of information; and
an extractor manager receiving the at least one wrapper retrieved by the wrapper manager, and extracting data from the currently viewed page of information.

15. The system as in claim 14, wherein the application further comprises a hyperservice manager that accepts extracted data from the extractor manager.

16. The system as in claim 15, wherein the application further comprises a plug-in to the user interface, which presents hyperservices to the user.

17. A plug-in for a browser to facilitate user interaction with the Internet, comprising:
a wrapper manager interfacing with a repository of wrappers to retrieve at least one wrapper associated with a currently viewed page of information displayed by the browser; and
an extractor manager receiving the at least one wrapper retrieved by the wrapper manager, and extracting data from the currently viewed page of information.

18. The plug-in as in claim 17, further comprising a hyperservice manager that accepts extracted data from the extractor manager.

19. The plug-in as in claim 18, wherein the hyperservice manager retrieves hyperservices from a hyperservice repository.

20. The plug-in as in claim 18, further comprising a plug-in to the browser, which presents the extracted data and hyperservices to the user.
